(19) United States
(12) Patent Application Publication
(10) Pub. No.: US 2018/0173753 A1
(43) Pub. Date: Jun. 21, 2018

(54) DATABASE SYSTEM AND METHOD FOR COMPILING SERIAL AND PARALLEL DATABASE QUERY EXECUTION PLANS

(71) Applicant: Futurewei Technologies, Inc., Plano, TX (US)

(72) Inventors: Chunfeng Pei, San Jose, CA (US); Li Zhang, San Jose, CA (US)

(21) Appl. No.: 15/414,560

(22) Filed: Jan. 24, 2017

Related U.S. Application Data
(60) Provisional application No. 62/435,592, filed on Dec. 16, 2016.

(51) Int. Cl. G06F 17/30

(52) U.S. Cl. CPC G06F 17/30445; G06F 17/30327; G06F 17/30463

(57) ABSTRACT

An apparatus, method, and non-transitory computer-readable media are provided for compiling serial and parallel database query execution plans. In use, a processing device parses a database query into a tree structure. Further, the processing device compiles a serial execution plan and a parallel execution plan for the database query, utilizing the tree structure. The processing device also identifies an amount of resources for executing the database query. The processing device selects the serial execution plan and/or the parallel execution plan, based on the identified amount of resources. To this end, the processing device executes the database query, utilizing the selected serial execution plan and/or the parallel execution plan.

### RELATED APPLICATION(S)

The present application claims priority to a provisional application filed on Dec. 16, 2016, under Application Ser. No. 62/435,592, which is incorporated herein by reference in its entirety.

### FIELD OF THE INVENTION

The present invention relates to database systems, and more particularly to compiling and executing query execution plans.

### BACKGROUND

Database systems typically process database queries by first establishing a database query execution plan for processing the queries in order to retrieve requested data. Such execution plans are typically compiled without any a priori knowledge of the processing resources available for carrying out the query execution plan. By compiling such query execution plans without consideration of resource availability, the performance of such query execution plans often exhibits inefficiencies and/or a lack of effectiveness. This is because such static query execution plans may not necessarily accommodate the specific resource availability at the node that will execute the same.

### SUMMARY

An apparatus, method, and non-transitory computer-readable media are provided for compiling serial and parallel database query execution plans.

An apparatus is provided for compiling serial and parallel database query execution plans. Included is a non-transitory memory comprising instructions, and one or more processors in communication with the memory. The one or more processors execute the instructions to parse a database query into a tree structure. Further, a serial execution plan and a parallel execution plan are compiled for the database query, utilizing the tree structure. An amount of resources is identified for executing the database query. Still yet, the serial execution plan and/or the parallel execution plan is selected, based on the identified amount of resources. To this end, the database query is executed, utilizing the selected serial execution plan and/or the parallel execution plan.

A method is provided for compiling serial and parallel database query execution plans. In use, a processing device parses a database query into a tree structure. Further, the processing device compiles a serial execution plan and a parallel execution plan for the database query, utilizing the tree structure. The processing device also identifies an amount of resources for executing the database query. The processing device selects the serial execution plan and/or the parallel execution plan, based on the identified amount of resources. To this end, the processing device executes the database query, utilizing the selected serial execution plan and/or the parallel execution plan.

A non-transitory computer-readable media storing computer instructions is also provided, that when executed by one or more processors, cause the one or more processors to perform the steps of parsing a database query into a tree structure; compiling a serial execution plan for the database query, utilizing the tree structure; compiling a parallel execution plan for the database query, utilizing the tree structure; identifying an amount of resources for executing the database query; selecting at least one of the serial execution plan or the parallel execution plan, based on the identified amount of resources; and executing the database query, utilizing the selected serial execution plan and/or the parallel execution plan.

In some processing device, method, or computer-readable media embodiments, information common to both the serial execution plan and the parallel execution plan may be identified. Further, such information may be stored in a common data structure shared by the serial execution plan and the parallel execution plan.

In some processing device, method, or computer-readable media embodiments, a degree of parallelism may be determined for the parallel execution plan based on the identified amount of resources, if the parallel execution plan is selected. The degree of parallelism is less than a number of entries of the database query. Further, the database query may be executed utilizing the parallel execution plan with the determined degree of parallelism, if the parallel execution plan is selected.

In some processing device, method, or computer-readable media embodiments, the database query may be executed utilizing a round robin routine, if the parallel execution plan is selected.

In some processing device, method, or computer-readable media embodiments, a change in the amount of resources may be identified. Further, the degree of parallelism may be adjusted based on the identified change in the amount of resources. As an option, the change in the amount of resources may be identified after a completion of the execution in connection with one of the entries of the database query. Further, the degree of parallelism for the parallel execution plan may be determined at runtime.

In some processing device, method, or computer-readable media embodiments, the database query may include a union operator, a union all operator, an except operator, and/or an intersect operator.

In some processing device, method, or computer-readable media embodiments, the execution may occur at each of a plurality of data storage nodes.

In some processing device, method, or computer-readable media embodiments, the identified amount of resources may include at least one of: a count of processing threads, a count of processing cores, or an amount of processing time.

In some processing device, method, or computer-readable media embodiments, the selection of at least one of the serial execution plan or the parallel execution plan is based on the identified amount of resources, by: comparing the identified amount of resources to a threshold; and selecting at least one of the serial execution plan or the parallel execution plan, based on the comparison.

To this end, in some optional embodiments, a database query execution plan may be selected based on a specific availability of resources. Further, such selection may be performed in real-time at a time of execution such that any indication of such resource availability is as accurate as possible. This may, in turn, result in improved performance when processing query execution plans, as well as an improved use of resources that would otherwise be foregone in systems that lack such feature. It should be noted that the aforementioned potential advantages are set forth for illustrative purposes only and should not be construed as limiting in any manner.

### BRIEF DESCRIPTION OF THE DRAWINGS

FIG. 1A illustrates a database system for executing both serial and parallel query execution plans, in accordance with an embodiment.

FIG. 1B illustrates a flowchart of a method for compiling both serial and parallel execution plans and executing the same at runtime, in accordance with an embodiment.

FIG. 2 illustrates a database system for executing both serial and parallel query execution plans, in accordance with another embodiment.

FIG. 3 illustrates a flowchart of a method for selecting a serial or parallel query execution plan based on available resources, in accordance with another embodiment.

FIG. 4 illustrates a flowchart of a method for executing a parallel execution plan, in accordance with an embodiment.

FIG. 5 illustrates a technique for storing information that is common to both a serial and parallel execution plan in a shared data structure, in accordance with an embodiment.

FIG. 6 illustrates a system for executing both serial and parallel query execution plans, in accordance with an embodiment.

FIG. 7 is a diagram of a network architecture, in accordance with an embodiment.

FIG. 8 is a diagram of an exemplary processing device, in accordance with an embodiment.

### DETAILED DESCRIPTION

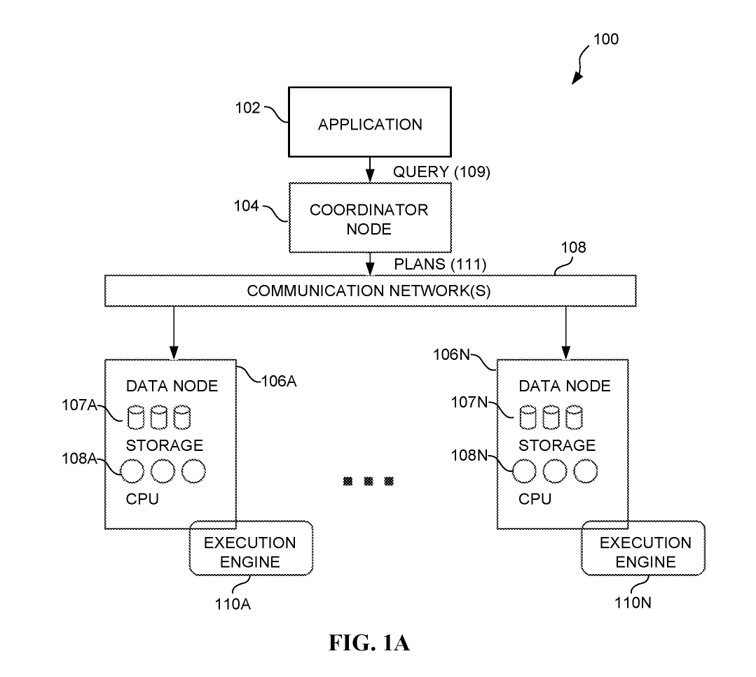

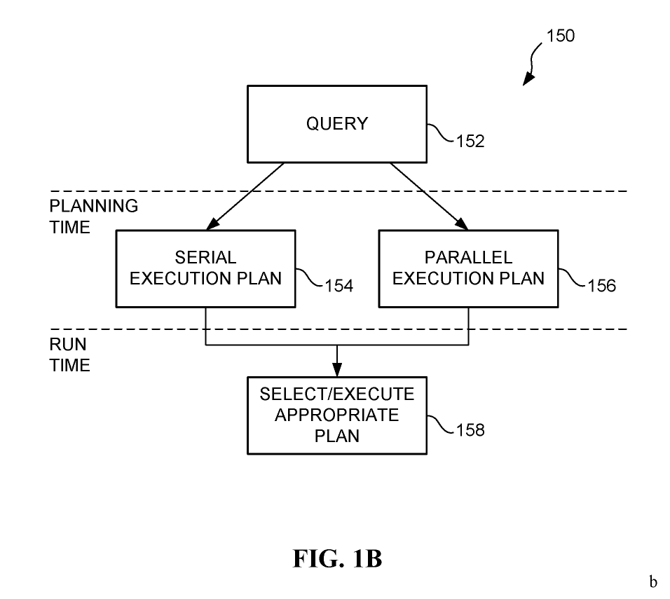

FIG. 1A illustrates a database system 100 for executing both serial and parallel query execution plans, in accordance with an embodiment. As shown, the database system 100 includes an application 102 in communication with a coordinator node 104 that, in turn, is in communication with a plurality of data storage nodes 106A-106N via one or more communication networks 108. Further, the data storage nodes 106A-106N each include a plurality of respective computer-readable storages 107A-107N, processors 108A-108N, and execution engines 110A-110N.

In one embodiment, data is stored on the storages 107A-107N in the form of database tables. Further, in various embodiments, different ones of the storages 107A-107N may store different partitions of such tables, in some use case scenarios. Further, in a use case that employs smaller tables, the corresponding data may be replicated and stored on a plurality (or all) of the storages 107A-107N.

In one possible embodiment, the database system 100 may include a database management system (DBMS). Further, such DBMS may include a massively parallel processing (MPP) database that is optimized for processing many queries (or portions thereof) in parallel. In such optional embodiment, the aforementioned processors 108A-108N may each be equipped with a dedicated, separate operating system and memory, and further be equipped with multiple internal cores to enhance parallel processing capabilities. More information will now be set forth regarding each of the foregoing components of the database system 100 as well as the interoperation thereof.

In the context of the present description, the application 102 may include any local or remote software program that is capable of issuing database queries 109 for the purpose of ultimately retrieving data stored on the data storage nodes 106A-106N. Further, the aforementioned queries 109 may each include any data structure that may be used to effect or support the retrieval of the data stored on the data storage nodes 106A-106N. Still yet, the coordinator node 104 may include any combination of hardware and software that is configured for generating query execution plans 111 for the queries 109 and further distributing the same to the data storage nodes 106A-106N so that such query execution plans 111 may be executed by the respective execution engines 110A-110N for retrieving the desired data and returning the same to the application 102 via the coordinator node 104.

In use, the application 102 issues the queries 109 to the coordinator node 104 which, in turn, processes the queries 109 in order to generate the execution plans 111 for distribution to the storage nodes 106A-106N for execution. Specifically, the coordinator node 104 generates both serial and parallel execution plans 111 which are both communicated to the data storage nodes 106A-106N. Upon receipt, the data storage nodes 106A-106N utilize the respective execution engines 110A-110N to process the serial and parallel execution plans 111 by: identifying an amount of available resources in connection with the corresponding storages 107A-107N and processors 108A-108N, and then executing at least one of the serial and/or parallel execution plans 111 based on such available resources.

In the context of the present description, the resource amount identification may refer to any measurement of resources. For example, in one embodiment, the resource amount identification may include a count of available processing threads. In another embodiment, the resource amount identification may include a count of available processing cores. In still other embodiment, an identification of available processing time may constitute the resource amount identification. In even still other embodiments, one or more memory resources available to a processor may also be considered a resource. In additional embodiments, the foregoing resource amount identification may be determined indirectly. For example, the count of available processing threads and/or available processing cores may be inferred via a measurement of a processor load.

Further, the measurement of such resources may be conducted in any desired manner. Just by way of example, available processing threads may be a predetermined number for each database instance, based on a thread allocation. Further, when one processing thread is used, such available number of threads may be reduced by one. To this end, the number of available threads is always known at any given time. Further, regarding processor core count, such parameter may be provided by an operating system in response to corresponding system calls.

By this design, the data storage nodes 106A-106N are capable of selecting between the serial and parallel execution plans 111 at runtime based on the real-time availability of resources at the data storage nodes 106A-106N. Further, as will soon become apparent, to the extent that the parallel execution plan 111 is selected for execution, a degree of parallelism may be determined in connection with such parallel execution plan 111, where such degree of parallelism is also based on the availability of resources at the data storage nodes 106A-106N.

FIG. 1B illustrates a flowchart of a method 150 for compiling both serial and parallel execution plans and executing the same at runtime, in accordance with an embodiment. As an option, the method 150 may be implemented in the context of any one or more of the embodiments set forth in any previous and/or subsequent figure(s) and/or description thereof. For example, the method 150 may be implemented by the database system 100 of FIG. 1A. However, it is to be appreciated that the method 150 may be implemented in other suitable environments.

As shown, a database query 152 is issued by an application (e.g. the application 102 of FIG. 1A). In various embodiments, the database query 152 may include a structured query language (SQL) query that may include any desired number of components (e.g. subqueries, statements, operators, data parameters, entries, etc.) of various types. For example, in the case of operators, such components may include, but are not limited to a union operator, a union all operator, an except operator, and/or an intersect operator. An exemplary query is set forth below in Table 1. It should be noted that such query of Table 1 is set forth for illustrative purposes only and should not be construed as limiting in any manner whatsoever.

TABLE 1

SELECT C11, C12, ... C1n
FROM table_1
[WHERE conditions]
UNION ALL
SELECT C21, C22, ... C2n FROM table_2
[WHERE conditions]
.......
UNION ALL
SELECT Cm1, Cm2, ... Cmn FROM table_m
[WHERE conditions];

With continuing reference to FIG. 1B, the database query 152 is sent to a node of a database system (e.g. the coordinator node 104 of the database system 100 of FIG. 1A) for generating an execution plan that is capable of being executed to retrieve the data outlined in the database query. As shown, both a serial execution plan 154 and a parallel execution plan 156 are compiled.

In the context of the present description, the serial execution plan 154 refers to any plan where execution of one or more components of the database query 152 is completed before another one or more components of the database query 152 is initiated. For example, in one possible embodiment, the serial execution plan 154 may include an array of entries that are ordered in a manner that dictates an order in which the entries of the array are processed, one-by-one. Further, each entry of the array may correspond with one or more components of the of the database query 152. By this design, such serial plan may include information that indicates/tracks an initial/current array entry, an order of operations, as well as any other additional information (e.g. that dictates use of a data buffer, etc.).

It should be noted that, in the serial plan, each array entry is independent of another, such that the order of processing may be dictated by the serial plan in any desired manner. For example, as mentioned earlier, the serial plan may simply dictate such processing order based on an order of the entries in the associated array. In use, the foregoing information of the serial plan is used when the plan is executed, such that a first entry of a subquery array may be processed, and a result returned. After the processing of the first entry is complete, the serial plan indicates a second entry to process so as to return another result. This may be repeated until all the entries of the array have been processed and results have been returned to a requesting application.

Further, the parallel execution plan 156 refers to any plan where execution of one or more components of the database query 152 is initiated before another one or more components of the database query 152 is completed such that different components are executed, at least in part, simultaneously in parallel. For example, in one possible embodiment, the parallel execution plan 156 may include an array of entries, in addition to information that indicates that the array entries may be processed in parallel.

By this design, such parallel plan may include information that supports parallel execution. Further, in one possible embodiment, the parallel plan may be used to dynamically determine the aforementioned degree of parallelism at a time of execution. Once the degree of parallelism is determined, a corresponding number of threads may be created, where each thread processes one entry of the array at a same time. Once each thread is done, the parallel plan directs processing to a next unprocessed array entry and so on, until every entry in the array has been processed. It should be noted that, in some embodiments, a serial plan may be converted to a parallel plan by adding the foregoing parallel plan-related information, in order to support parallel processing.

In the context of a specific optional embodiment involving queries such as that of Table 1, a query may involve multiple subqueries in the form of select statements that are each the subject of a union all operator. In such embodiment, the array entries of different subqueries (represented by the select statements) may be run in parallel. To this end, the foregoing parallelism may be applied at the select statement/subquery level, in the present embodiment.

As will soon become apparent, the serial and parallel execution plans 154/156 may be compiled to use an append operator. Such append operation may be constructed to represent a list of query components (e.g. sub-queries, etc.) whose results may be merged, appended, and returned to a next stage of query operation. Specifically, each sub-query may be inserted into an array such that, when executed at execution time, the array may be processed, one entry at a time during serial execution, or in parallel using different threads for different sub-queries during parallel execution.

To this end, the serial and parallel execution plans 154/156 are distributed to appropriate nodes (e.g. the data storage nodes 106A-106N of FIG. 1A) so that respective execution engines (e.g. the execution engines 110A-110N of FIG. 1A) can select among the serial and parallel execution plans 154/156 for executing the same and retrieving the corresponding data. By generating both serial and parallel execution plans 154/156 and distributing the same to appropriate nodes that store the desired data, a decision may be made at such nodes in operation 158 as to which of the serial and parallel plans is most suitable in view of the real-time status of any underlying resources that would be relied upon to execute the selected plan.

For example, in one possible embodiment, a threshold may be used in connection with the decision to use the serial or parallel execution plans. In the context of the present description, the aforementioned threshold may refer to any static or dynamic value which may be compared against an amount of available resources.

Specifically, in one optional embodiment, the foregoing threshold may correspond to a number of threads that is necessary for executing a minimum number of entries (e.g. sub-queries) under the parallel execution plan 156. In such embodiment, an execution engine may determine a number of threads of processors (e.g. the processors 108A-108N of FIG. 1) that are available for executing a particular query. If such number of threads is below a threshold, the serial execution plan 154 may be chosen for execution.

On the other hand, if such number of threads is above the aforementioned threshold, the parallel execution plan 156 may be chosen for execution. Further, a degree of parallelism in connection with the execution of such parallel execution plan 156 may be based on the number of available threads. For example, if there is an insufficient number of threads to run all entries in parallel, a subset of such entries may be initially executed and, upon completion of the execution of such entries, the resources of the particular data storage node may be reassessed to determine a size of the next subset of entries to be subsequently executed.

In the foregoing embodiment, a number of available threads may be the subject of change over time. Thus, at runtime/execution time, such number may be dynamically determined in real-time by, for example, counting a number of available CPU cores and then (assuming a constant thread-to-core ratio) calculating the corresponding number of available threads. As an additional option, the foregoing identified number of available threads may also drive a degree of parallelism to be used, if the threshold is met. To this end, the degree of parallelism may be dynamically determined, in some embodiments.

In another optional embodiment, the aforementioned threshold may correspond to a number of CPU cores. In such embodiment, it may be determined that a system has X cores, and it may be predetermined that only half of such X cores may be used for parallel execution (to avoid an overload of resources). In such case, the threshold will be X/2, and any parallel processing that is determined to exceed such threshold (by itself or in aggregate) will be prevented.

In still yet another optional embodiment, the aforementioned threshold may correspond to an amount of memory resources available to a processor. In such embodiment, it may be determined that a system has X GB of memory, and it may be predetermined that only twenty percent (20%) of such X GB of memory may be used for parallel execution (so that sufficient memory may be effectively used for other purposes). In such case, the threshold may be X*0.2, and any parallel processing that is determined to exceed such threshold (by itself or in aggregate) will be prevented.

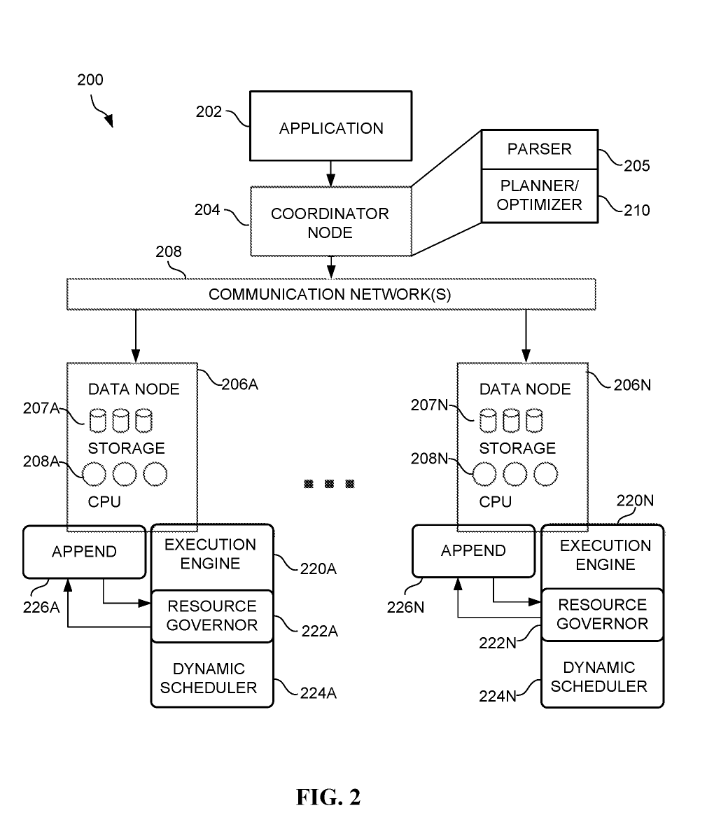

FIG. 2 illustrates a database system 200 for executing both serial and parallel query execution plans, in accordance with another embodiment. As an option, the database system 200 may be implemented in the context of any one or more of the embodiments set forth in any previous and/or subsequent figure(s) and/or description thereof. For example, the database system 200 may be implemented in the context of the database system 100 of FIG. 1A and further be capable of carrying out the method 150 of FIG. 1B. However, it is to be appreciated that the database system 200 may be implemented in the other suitable environments.

Similar to the database system 100 of FIG. 1A, the database system 200 includes an application 202 in communication with a coordinator node 204 that, in turn, is in communication with a plurality of data storage nodes 206A-206N via one or more communication networks 208. Further, the data storage nodes 206A-206N each include a plurality of respective storages 207A-207N, processors 208A-208N, and execution engines 220A-220N.

In addition, the coordinator node 204 of the database system 200 includes a parser 205 and a database query planner/optimizer 210. Further, the execution engines 220A-220N of the data storage nodes 206A-206N are each equipped with a resource governor 222A-222N and a dynamic scheduler 224A-224N. Still yet, each execution engine 220A-220N is configured for processing one or more append operators 226A-226N that are included in plans distributed by the coordinator node 204 and executed by the execution engines 220A-220N.

In use, the application 202 issues the queries to the parser 205 of the coordinator node 204 which, in turn, parses the queries into at least one tree structure. In the context of the present description, such tree structure may include any data structure including hierarchically-organized components (e.g. entries and/or sub-queries reflecting various operations). In use, the tree structure is configured for being processed to produce an execution plan for the corresponding query. In one embodiment, the parser 205 may include a SQL parser. Further, the tree structure(s) may take the form of a binary tree, where each node of the binary tree represents one or more operations that were parsed from the aforementioned queries.

Accordingly, the query planner/optimizer 210 of the coordinator node 204 then processes the tree structure for generating and optimizing multiple execution plans, namely the aforementioned serial execution plan and the parallel execution plan. As mentioned earlier, in one embodiment involving the serial execution plan, the foregoing entries may be organized in a predetermined serial order corresponding to the aforementioned hierarchical organization. Further, in another embodiment involving the parallel execution plan, the foregoing entries may be organized into groups of entries that are devoid of any interdependencies that would otherwise preclude processing entry groups in parallel.

In any case, both execution plans are compiled and distributed to each of the data storage nodes 206A-206N so that the appropriate one of the execution plans may be selected and executed by each of the corresponding data storage nodes 206A-206N utilizing the corresponding one of the execution engines 220A-220N. Specifically, in response to the receipt of a corresponding pair of execution plans, the resource governors 222A-222N of the execution engines 220A-220N each identify threads of the processors 208A-208N that are currently available at the corresponding data storage node 206A-206N. Given such accounting of resource availability, the dynamic schedulers 224A-224N of the execution engines 220A-220N each selects either the serial or parallel execution plan for the corresponding data storage node 206A-206N and executes the same to retrieve the requested data from the appropriate respective storages 207A-207N of the corresponding data storage node 206A-206N.

Further, in the event that the parallel execution plan is executed, a degree of parallelism is selected based on the number of available processing threads. In the context of the present description, such degree of parallelism may be a number of processing elements (e.g. threads, cores, units, etc.) that are to be simultaneously (at least in part) used to process components (e.g. entries, sub-queries) of a database query in parallel. To the extent that: 1) such degree of parallelism is less than the number of entries in a parallel execution plan, and 2) unprocessed entries remain after processing of one or more other entries has completed; the resource governors 222A-222N and the dynamic schedulers 224A-224N may repeat the foregoing process of identifying available resources and setting an updated degree of parallelism accordingly.

In one possible embodiment, the degree of parallelism may refer to a number of threads that can be scheduled at the same time to process array entries. Further, the degree of parallelism may be selected based on a number of factors. For example, the degree of parallelism may be selected based on a number of available CPU cores, an amount of memory resources available, and even be user-specified. Specifically, in the case of CPU cores where it is predetermined that each physical CPU core can run up to two (2) threads, a number of the available CPU cores may be multiplied by two (2), in order to determine the degree of parallelism.

In another embodiment where an amount of available memory resources dictates the degree of parallelism, such degree of parallelism may be calculated by dividing an amount of total memory available by an amount of memory required for supporting one (1) degree of parallelism. In still another embodiment where the degree of parallelism is user selected, a user who ran a query may want to specify a maximum degree of parallelism to be sixteen (16), or some other number, to limit parallelism so that it does not consume all available resources. In still yet another embodiment, each of the foregoing factors may be considered, and a minimum or average of such factors may be used as the degree of parallelism.

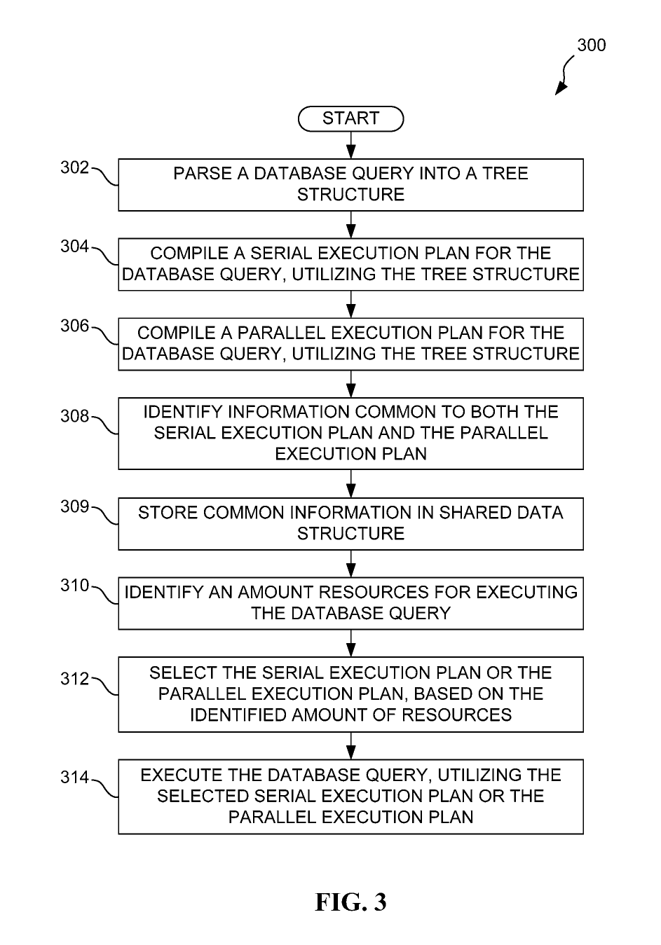

FIG. 3 illustrates a flowchart of a method 300 for selecting a serial or parallel query execution plan based on available resources, in accordance with another embodiment. As an option, the method 300 may be implemented in the context of any one or more of the embodiments set forth in any previous and/or subsequent figure(s) and/or description thereof. For example, the method 300 may be implemented in the context of the database systems 100/200 of FIGS. 1A-2. However, it is to be appreciated that the method 300 may be implemented in other suitable environments.

As shown, in operation 302, a database query is parsed into a tree structure after being received. In one possible embodiment, such query may be received from an application (e.g. the application 102/202 of FIGS. 1A-2) and may be parsed by a parser (e.g. the parser 205 of FIG. 2). Further, in the context of the present embodiment, the parsing may include any processing that results in components (e.g. entries, sub-queries) being identified in the database query in a manner that permits the compilation of an execution plan, as described earlier.

In operation 304, a serial execution plan is compiled for the database query, utilizing the tree structure. Similarly, in operation 306, a parallel execution plan is compiled for the database query, utilizing the tree structure. In various embodiments, such plan compilation may include the organization of the entries in a serial or parallel fashion and including associated code or instructions for permitting execution of the respective plans accordingly. Further, in one possible embodiment, both of the foregoing execution plans may be generated by a database query planner/optimizer (e.g. query planner/optimizer 210 of FIG. 2).

In some implementations, information common to both the serial execution plan and the parallel execution plan may be identified in operation 308. In one possible embodiment, such common information that include the components (e.g. entries, sub-queries) themselves along with any other data and/or code that are required by both the serial execution plan and the parallel execution plan. Still yet, in operation 309, such information is stored in a common data structure shared by the serial execution plan and the parallel execution plan. To this end, during the compilation, an amount of storage that is required at an associated coordinator node for storing the serial and parallel execution plan may be reduced, since multiple instances of the same information need not necessarily be separately and redundantly stored.

After the planning is complete, both of the execution plans are subsequently distributed to a plurality of execution engines of different data storage nodes (e.g. the execution engines 220A-220N of the data storage node 206A-206N of FIG. 2). Again, to the extent that operations 308-309 have been carried out, during the planning, an amount of storage that is required at the different data storage nodes for storing the serial and parallel execution plan may also be reduced.

With continuing reference to FIG. 3, an amount of resources for executing the database query is then identified in operation 310. In the context of the present description, the resource amount identification may refer to any measurement of processing resources. For example, in one embodiment, the resource amount identification may include a count of available processing threads. In another embodiment, the resource amount identification may include a count of available processing cores. In still other embodiment, an identification of available processing time may constitute the resource amount identification. In even still other embodiments, the resource amount identification may include a measurement of a processor load.

In use, such resource amount may be identified in any desired manner. For example, in one possible embodiment, the operation 310 may be carried out utilizing a resource governor of an execution engine (e.g. the resource governors 222A-222N of the execution engines 220A-220N of FIG. 2). Further, operation 310 may be carried out at any point during runtime (e.g. at any time when execution of an execution plan is ready, imminent, and/or already under way).

In any case, the serial execution plan or the parallel execution plan is selected in operation 312, based on the amount of resources identified in operation 310. As mentioned earlier, such selection may be carried out utilizing any technique that is a function of the amount of resources identified in operation 310. For example, as described earlier, the selection may involve a comparison of the amount of available resources against a minimum threshold. Specifically, such threshold may be set such that, if available resources simply cannot feasibly support parallel execution and/or would overuse resources, serial execution may be selected. Otherwise, parallel execution is selected. In other embodiments, algorithms, a look-up table, or other logic may be used to determine whether a serial or parallel execution plan constitutes an efficient and/or effective use of available resources given an amount of such resources.

Thus, the database query is executed in operation 314, utilizing the selected serial execution plan or the parallel execution plan. In one possible embodiment, the operations 312-314 may be carried out utilizing a resource governor of an execution engine (e.g. the dynamic schedulers 224A-224N of the execution engines 220A-220N of FIG. 2).

To this end, in some optional embodiments, a database query execution plan may be selected based on a specific availability of resources. Further, such selection may be performed in real-time at a time of execution such that any indication of such resource availability is as accurate as possible. This may, in turn, result in improved performance when processing query execution plans as well as an improved use of resources that would otherwise be foregone in systems that lack such feature. More illustrative information will now be set forth regarding various optional architectures and uses in which the foregoing method may or may not be implemented, per the desires of the user. It should be noted that the following information is set forth for illustrative purposes and should not be construed as limiting in any manner. Any of the following features may be optionally incorporated with or without the other features described.

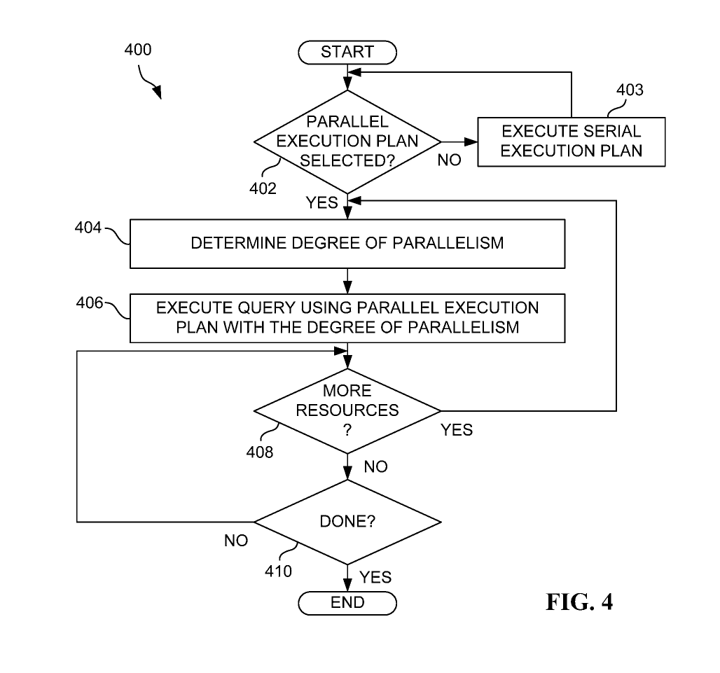

FIG. 4 illustrates a flowchart of a method 400 for executing a parallel execution plan, in accordance with an embodiment. As an option, the method 400 may be implemented in the context of any one or more of the embodiments set forth in any previous and/or subsequent figure(s) and/or description thereof. For example, in one embodiment, the method 400 may be carried out in the context of the operation 314 of FIG. 3 in the event that a parallel execution plan is selected/executed. However, it is to be appreciated that the method 400 may be implemented in other environments.

It is determined in decision 402 whether a parallel execution plan has been selected. In one embodiment, such selection may be carried out per the operation 312 of FIG. 3. In response to the parallel execution plan not being selected per decision 402, a serial execution plan is executed in operation 403.

On the other hand, if the parallel execution plan is selected per decision 402, a degree of parallelism is determined for the parallel execution plan in operation 404, based on an identified amount of resources. As mentioned earlier, such degree of parallelism may be a number of processing elements (e.g. threads, cores, units, etc.) that are to be simultaneously (at least in part) used to process components (e.g. entries, sub-queries) of a database query in parallel. Further, such number (of processing elements) is set to be less than or equal to a number of components of the database query, since that is the maximum number of processing elements that would be necessary to run all database query components in parallel. In other words, if there are X database query components and all of the X database query components are capable of being executed in parallel via X processing elements, there is no need to allocate any number of processing elements that would exceed X. Still yet, the operation 404 may be carried out at runtime.

With continuing reference to FIG. 4, the database query is shown to be then executed in operation 406 utilizing the parallel execution plan with the determined degree of parallelism. As an option, the database query may be executed utilizing a round robin routine. For example, in one possible embodiment, given X query components (e.g. entries) from an execution plan that are placed in a queue to be processed by Y processing elements such as threads (where X>Y), Z query components (where Z<X) may be assigned to the Y processing elements and, as they are completed, any of the Y processing elements that become available may be assigned to a next available query component until all X query components are processed.

Throughout the execution of the database query, it is determined per decision 408 whether there has been a change in an amount of resources (e.g. see operation 310 of FIG. 3). In particular, it is determined whether more resources have become available (which are not allocated to other tasks). If so, the degree of parallelism is adjusted (e.g. augmented) and execution continues per operation 404-406. In possible embodiment, the foregoing change in the amount of resources may be identified after a completion of each one of the components of the database query.

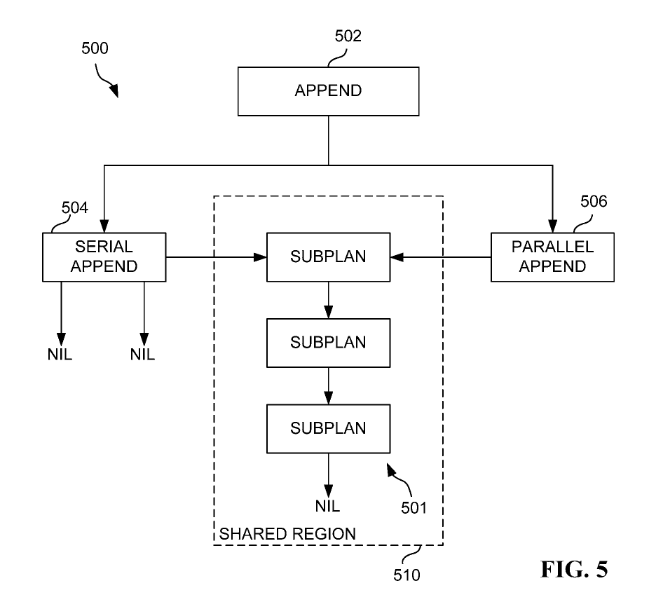

FIG. 5 illustrates a technique 500 for storing information that is common to both a serial and parallel execution plan in a shared data structure, in accordance with an embodiment. As an option, the technique 500 may be implemented in the context of any one or more of the embodiments set forth in any previous and/or subsequent figure(s) and/or description thereof. For example, the technique 500 may be implemented in the context of operations 308-309 of FIG. 3. However, it is to be appreciated that the technique 500 may be implemented in other suitable environments.

As mentioned earlier, information 501 common to both a serial execution plan 504 and a parallel execution plan 506 may be identified in connection with an append operator, for example. Further, such information may be stored in a common data structure 510 shared by the serial execution plan and the parallel execution plan. For example, in one possible embodiment, the common data structure 510 may store information resulting from query processing, as well as any data (e.g. an intermediate result) that needs to be returned to another level. This may, for example, be the case when processing multiple select operators, as set forth earlier in connection with Table 1. To this end, during planning, an amount of storage that is required at an associated coordinator node for storing the serial and parallel execution plan may be reduced.

As a further option, buffers at a coordinator node (e.g. the coordinator 104/204 of FIGS. 1A-2) and/or storage nodes (e.g. the storage nodes 106A-106N/206A-206N of FIGS. 1A-2) may be allocated for storing any data/code of the serial execution plan and the parallel execution plan. In such case, a size and/or number of such buffers may be reduced as a result of the use of the aforementioned common data structure 510, since less data will need to be stored.

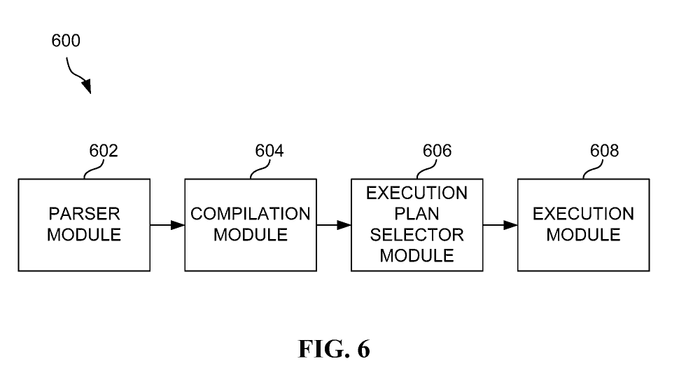

FIG. 6 illustrates a database query execution system 600 for executing both serial and parallel query execution plans, in accordance with an embodiment. As an option, the database query execution system 600 may be implemented with one or more features of any one or more of the embodiments set forth in any previous and/or subsequent figure(s) and/or the description thereof. However, it is to be appreciated that the database query execution system 600 may be implemented in the other suitable environments.

As shown, a parser means in the form of a parser module 602 is provided for parsing a database query into a tree structure, in accordance, for example, with operation 302 of FIG. 3. In various embodiments, the parser module 602 may include, but is not limited to the parser 205 of FIG. 2, at least one processor (to be described later) and any software controlling the same, and/or any other circuitry capable of the aforementioned functionality.

Also included is a compilation means in the form of a compilation module 604 in communication with the parser module 602 for compiling a serial execution plan and a serial execution plan for the database query, utilizing the tree structure, in accordance, for example, with operations 304-306 of FIG. 3, respectively. In various embodiments, the compilation module 604 may include, but is not limited to the planner/optimizer 210 of FIG. 2, at least one processor (to be described later) and any software controlling the same, and/or any other circuitry capable of the aforementioned functionality.

Still further provided is an execution plan selector means in the form of an execution plan selector module 606 in communication with the compilation module 604 for selecting at least one of the serial execution plan or the parallel execution plan, based on an identified amount of resources, in accordance, for example, with operation 312 of FIG. 3. In various embodiments, the execution plan selector module 606 may include, but is not limited to the resource governor 222A of FIG. 2, at least one processor (to be described later) and any software controlling the same, and/or any other circuitry capable of the aforementioned functionality.

Further included is an execution means in the form of an execution module 608 in communication with the execution plan selector module 606 for executing the database query, utilizing the selected at least one of the serial execution plan or the parallel execution plan, in accordance, for example, with operation 314 of FIG. 3. In various embodiments, the execution module 608 may include, but is not limited to the dynamic scheduler 224A of FIG. 2, at least one processor (to be described later) and any software controlling the same, and/or any other circuitry capable of the aforementioned functionality.

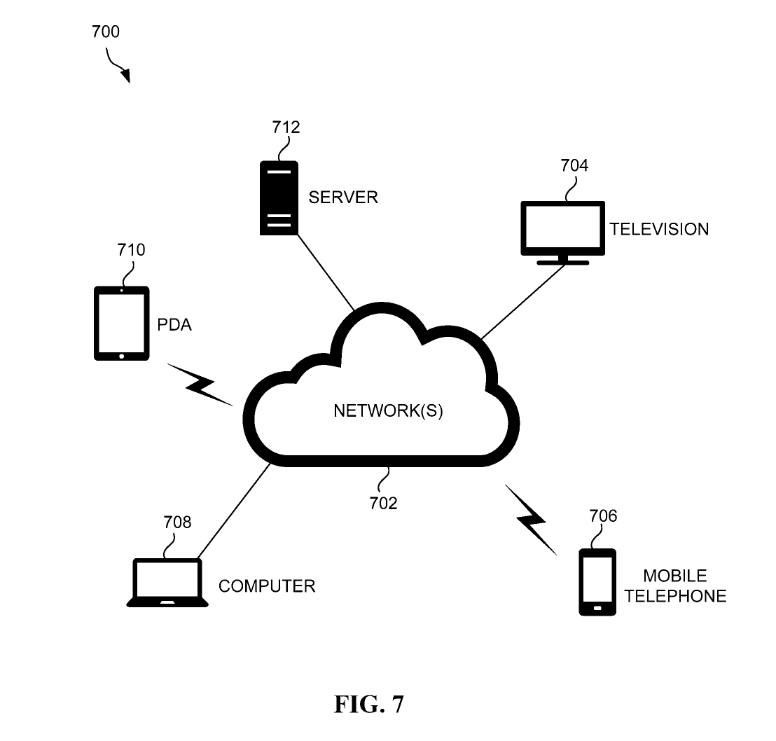

FIG. 7 is a diagram of a network architecture 700, in accordance with an embodiment. As shown, at least one network 702 is provided. In various embodiments, any one or more components/features set forth during the description of any previous figure(s) may be implemented in connection with any one or more components 704-712 coupled to the at least one network 702. For example, in various embodiments, any of the components 704-712 may be equipped with the coordinator node 104 of FIG. 1 and/or one or more data nodes 106A-N of FIG. 1, for compiling and/or executing serial and parallel database query execution plans.

In the context of the present network architecture 700, the network 702 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 702 may be provided.

Coupled to the network 702 is a plurality of devices. For example, a server 712 and a computer 708 may be coupled to the network 702 for communication purposes. Such computer 708 may include a desktop computer, lap-top computer, and/or any other type of logic. Still yet, various other devices may be coupled to the network 702 including a personal digital assistant (PDA) device 710, a mobile phone device 706, a television 704, etc.

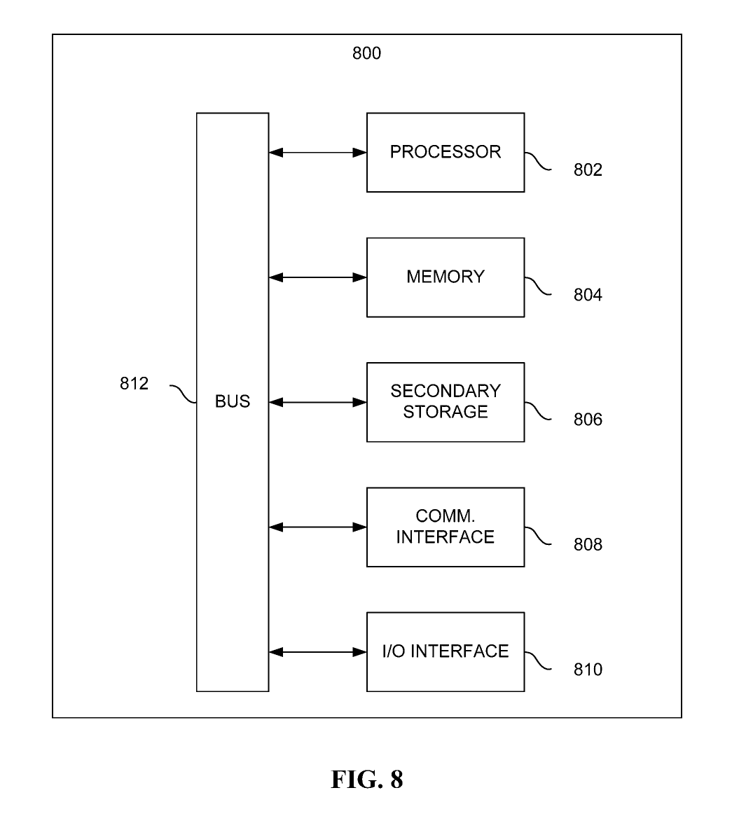

FIG. 8 is a diagram of an exemplary processing device 800, in accordance with an embodiment. As an option, the processing device 800 may be implemented in the context of any of the devices of the network architecture 700 of FIG. 7. However, it is to be appreciated that the processing device 800 may be implemented in other suitable environments. For example, in various embodiments, the coordinator node 104 of FIG. 1 and/or one or more data nodes 106A-N of FIG. 1 may be implemented on the processing device 800, for compiling and/or executing serial and parallel database query execution plans.

As shown, the processing device 800 includes at least one processor 802 which is connected to a bus 812 for processing data (e.g. see steps 302-314 of FIG. 3, etc.) The processing device 800 also includes memory 804 [e.g., hard disk drive, solid state drive, random access memory (RAM), etc.] coupled to the bus 812. The memory 804 may include one or more memory components, and may even include different types of memory. Further included is a communication interface 808 (e.g. a network adapter, modem, etc.) and an input/output (I/O) interface 810 (e.g. display, speaker, microphone, touchscreen, touchpad, mouse interface, etc.).

The processing device 800 may also include a secondary storage 806. The secondary storage 806 coupled to the bus 812 and/or to other components of the processing device 800. The secondary storage 806 can include, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the memory 804, the secondary storage 806, and/or any other memory, for that matter. Such computer programs, when executed, enable the processing device 800 to perform various functions (as set forth above, for example). Memory 804, secondary storage 806 and/or any other storage comprise non-transitory computer-readable media.

In one embodiment, the at least one processor 802 executes instructions in the memory 804 or in the secondary storage 806 to compile/execute serial and parallel database query execution plans, by: parsing a database query into a tree structure; compiling a serial execution plan for the database query, utilizing the tree structure; compiling a parallel execution plan for the database query, utilizing the tree structure; identifying an amount of resources for executing the database query; selecting at least one of the serial execution plan or the parallel execution plan, based on the identified amount of resources; and executing the database query, utilizing the selected serial execution plan and/or the parallel execution plan.

In some embodiments, information common to both the serial execution plan and the parallel execution plan may be identified. Further, the information may be stored in a common data structure shared by the serial execution plan and the parallel execution plan.

In some embodiments, a degree of parallelism may be determined for the parallel execution plan based on the identified amount of resources, if the parallel execution plan is selected. The degree of parallelism is less than a number of entries of the database query. Further, the database query may be executed utilizing the parallel execution plan with the determined degree of parallelism, if the parallel execution plan is selected.

In some embodiments, the database query may be executed utilizing a round robin routine, if the parallel execution plan is selected.

In some embodiments, a change in the amount of resources may be identified. Further, the degree of parallelism may be adjusted based on the identified change in the amount of resources. As an option, the change in the amount of resources may be identified after a completion of the execution in connection with one of the entries of the database query. Further, the degree of parallelism for the parallel execution plan may be determined at runtime.

In some embodiments, the database query may include a union operator, a union all operator, an except operator, and/or an intersect operator.

In some embodiments, the execution may occur at each of a plurality of data storage nodes.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), or the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; or the like.

It should be understood that the arrangement of components illustrated in the Figures described are exemplary and that other arrangements are possible. It should also be understood that the various system components defined by the claims, described below, and illustrated in the various block diagrams represent logical components in some systems configured according to the subject matter disclosed herein.

For example, one or more of these system components may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discrete logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. A processing device, comprising:
a non-transitory memory comprising instructions; and
one or more processors in communication with the memory, wherein the one or more processors execute the instructions to:
parse a database query into a tree structure;
compile a serial execution plan for the database query, utilizing the tree structure;
compile a parallel execution plan for the database query, utilizing the tree structure;
identify an amount of resources for executing the database query;
select at least one of the serial execution plan or the parallel execution plan, based on the identified amount of resources; and
execute the database query, utilizing the selected at least one of the serial execution plan or the parallel execution plan.

2. The processing device of claim 1, wherein the one or more processors further execute the instructions to:
identify information common to both the serial execution plan and the parallel execution plan; and
store the information in a common data structure shared by the serial execution plan and the parallel execution plan.

3. The processing device of claim 1, wherein the one or more processors further execute the instructions to:
determine a degree of parallelism for the parallel execution plan that is less than a number of entries of the database query based on the identified amount of resources, if the parallel execution plan is selected; and
execute the database query utilizing the parallel execution plan with the determined degree of parallelism, if the parallel execution plan is selected.

4. The processing device of claim 3, wherein the database query is executed utilizing a round robin routine, if the parallel execution plan is selected.

5. The processing device of claim 3, wherein the one or more processors further execute the instructions to:
identify a change in the amount of resources; and
adjust the degree of parallelism based on the identified change in the amount of resources.

6. The processing device of claim 5, wherein the change in the amount of resources is identified after a completion of the execution in connection with one of the entries of the database query.

7. The processing device of claim 3, wherein the degree of parallelism for the parallel execution plan is determined at runtime.

8. The processing device of claim 1, wherein the database query includes at least one of a union operator, a union all operator, an except operator, or an intersect operator.

9. The processing device of claim 1, wherein the execution occurs at each of a plurality of data storage nodes.

10. The processing device of claim 1, wherein the identified amount of resources includes at least one of: a count of processing threads, a count of processing cores, or an amount of processing time.

11. The processing device of claim 1, wherein the selection of at least one of the serial execution plan or the parallel execution plan is based on the identified amount of resources, by:
comparing the identified amount of resources to a threshold; and
selecting at least one of the serial execution plan or the parallel execution plan, based on the comparison.

12. A computer-implemented method comprising:
parsing a database query into a tree structure;
t compiling a serial execution plan for the database query, utilizing the tree structure;
compiling a parallel execution plan for the database query, utilizing the tree structure;
identifying an amount of resources for executing the database query;
selecting at least one of the serial execution plan or the parallel execution plan, based on the identified amount of resources; and
executing the database query, utilizing the selected at least one of the serial execution plan or the parallel execution plan.

13. The method of claim 12, and further comprising:
identifying information common to both the serial execution plan and the parallel execution plan; and
storing the information in a common data structure shared by the serial execution plan and the parallel execution plan.

14. The method of claim 12, and further comprising:
determining a degree of parallelism for the parallel execution plan that is less than a number of entries of the database query based on the identified amount of resources, if the parallel execution plan is selected; and
executing the database query utilizing the parallel execution plan with the determined degree of parallelism, if the parallel execution plan is selected.

15. The method of claim 14, wherein the database query is executed utilizing a round robin routine, if the parallel execution plan is selected.

16. The method of claim 14, and further comprising:
identifying a change in the amount of resources; and
adjusting the degree of parallelism based on the identified change in the amount of resources.

17. The method of claim 16, wherein the change in the amount of resources is identified after a completion of the execution in connection with one of the entries of the database query.

18. The method of claim 14, wherein the degree of parallelism for the parallel execution plan is determined at runtime.

19. The method of claim 12, wherein the database query includes at least one of a union operator, a union all operator, an except operator, or an intersect operator.

20. The method of claim 12, wherein the execution occurs at each of a plurality of data storage nodes.

21. The method of claim 12, wherein the identified amount of resources includes at least one of: a count of processing threads, a count of processing cores, or an amount of processing time.

22. The method of claim 12, wherein the selection of at least one of the serial execution plan or the parallel execution plan is based on the identified amount of resources, by:
comparing the identified amount of resources to a threshold; and
selecting at least one of the serial execution plan or the parallel execution plan, based on the comparison.

23. A non-transitory computer-readable media storing computer instructions, that when executed by one or more processors, cause the one or more processors to perform the steps of:
parsing a database query into a tree structure;
compiling a serial execution plan for the database query, utilizing the tree structure;
compiling a parallel execution plan for the database query, utilizing the tree structure;
identifying an amount of resources for executing the database query;
selecting at least one of the serial execution plan or the parallel execution plan, based on the identified amount of resources; and
executing the database query, utilizing the selected at least one of the serial execution plan or the parallel execution plan.
